(19) United States
(12) Patent Application Publication
(10) Pub. No.: US 2016/0180738 A1
(43) Pub. Date: Jun. 23, 2016

(54) Life Experiences Engine

(71) Applicants: Dustin Garis, Charlotte, NC (US); Michael Iskandar, Charlotte, NC (US)

(72) Inventors: Dustin Garis, Charlotte, NC (US); Michael Iskandar, Charlotte, NC (US)

(21) Appl. No.: 14/886,076

(22) Filed: Oct. 18, 2015

Related U.S. Application Data
(60) Provisional application No. 62/065,737, filed on Oct. 19, 2014.

(51) Int. Cl. G09B 19/00; G09B 5/00

(52) U.S. Cl. CPC G09B 19/00; G09B 5/00

(57) ABSTRACT

A system that links virtual content with offline experiences, utilizing mobile, social, and digital tools for collecting, organizing, and delivering relevant content for use in the non-virtual world.

### CROSS-REFERENCE TO PROVISIONAL PATENT APPLICATIONS

### EFS ID: 20454727

### APPLICATION No. 62/065,737

### BACKGROUND OF THE INVENTION

1. Field of the Invention

This invention relates to the fields of personal improvement, organizational effectiveness, and digital and experiential marketing. More specifically, the invention involves new approaches, applications, and technologies with mobile, digital, social, and offline activities that facilitate the interconnection between digital content and real world actions, for the purpose of increasing personal enrichment, and also improving marketing effectiveness, employee engagement, and the interface between people and organizations (and their products/services).

2. Context of the Invention.

People are increasingly adopting new technologies, devices and applications, to improve their quality of life, whether it's informational, entertainment, social connections, or other. As part of this trend, people are also seeking ways to improve the quality of their real life experiences beyond the virtual world of the device itself. Opportunities for bridging this gap of virtual tools and physical experiences would be of significant interest. Various approaches have been attempted (such as pedometers), yet these don't help people improve their overall set of experiences for a more memorable life. A new solution is needed that can help people find, share, track real life experiences in a way that is motivating (such as with a measurement of life richness), actionable (such as with tailored suggestions that are situationally relevant), easy (such as with a digital assistant to guide people), enjoyable (such as with digital representation of non-digital memories gained), and social (such as with connecting people with shared interest for participating in activities).

From a business standpoint, there is a trend of increasing interconnectedness among physical items and the digital world. Consumers are expecting products and services to be integrated into their web of digital interactions. This creates a demand for products and services to incorporate hardware and software technologies that support the interaction between consumer's digital and physical world. This includes things like the connected refrigerator, the digital thermostat, smart TVs, credit cards, clothing, and other offerings. The challenge has been in developing a program that can connect multiple aspects of the digital and non-digital world in a meaningful way that actually improves the quality of life experience for people, beyond just the functional attributes of the product itself.

As brands compete to engage consumers with marketing programs, they are ever seeking opportunities to do so with greater effectiveness by making a meaningful impact on people's lives. The current marketing options are largely ineffective, in part due to the crowded media landscape, the changing consumer behaviors, and the growing number of engagement vehicles. For example, many digital marketing methods, like banner ads, generally have a low degree of impact, and often are ignored altogether. Experiential or event marketing, on the other hand, is engaging, yet ineffective in achieving significant scale. A new solution is needed to meet these changes and advance business objectives, by marrying the scale efficiencies of digital programs with the impactful nature of real-life experiential activities.

From an organizational perspective, there is tremendous need for improving operational efficiency and quality output by increasing employee engagement, retention, and innovation. Especially as competition increases for quality talent and competitive operations, the current methodologies for organizational design fall short. Millennials, in particular, are seeking more out of their professional life than traditional perks and office structures. A scalable solution is needed to address the current state of uninspiring and routine-based work conditions, and enable organizations to provide a work environment that is rich in experience, for positive impact on quality of life and quality of work.

### BRIEF SUMMARY OF THE INVENTION

In accordance with the purposes of the present invention, as embodied and broadly described herein, the present invention includes systems, methods, apparatus, and computer program products that link virtual content with offline experiences. It utilizes digital tools and methods for collecting, organizing, and delivering relevant data and content for use in the non-virtual world and the reverse. This enables organizations to digitally reach targeted users (which may include consumers and employees) with situationally-relevant content, for interaction with their offline experiences, and the translation of such back into a digital context. Likewise, individuals use the digital system to explore their non-virtual world, and interact with other users' real-life experiences.

Embodiments of the invention include an application on web, mobile, and digital devices, which integrate data from various sources, including peripheral devices, cloud services, social networks, and user input. Using methods and utilities, including algorithms and databases, this data is housed and assimilated into an assessment of the user's situational context, and results in a corresponding set of content. This content may be used to initiate offline actions, which upon activation, may be added to the collection of data and content. This expands the reach and accuracy of organizational and individual communications, as well as creates a digital linkage between brands and non-digital experiences.

### BRIEF DESCRIPTION OF THE DRAWINGS

FIG. 1 shows a high-level process used by one embodiment of the primary application.

FIG. 2 illustrates mechanisms within the model that enable the manipulation of data and content.

FIG. 3 identifies elements included in the algorithms that enable the scoring, matching, communicating, and tailoring of content and user behavior.

FIG. 4 is a schematic of technical elements included in the model.

FIG. 5 outlines the basic functional process of the model.

### DETAILED DESCRIPTION OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa unless explicitly stated otherwise. Also, as used herein, the term “a” and/or “an” shall mean “one or more,” even though the phrase “one or more” is also used herein. Like numbers refer to like elements throughout.

The accompanying drawings, which are incorporated in and form a part of the specification, illustrate the embodiments of the present invention and, together with the description, serve to explain the principles of the invention.

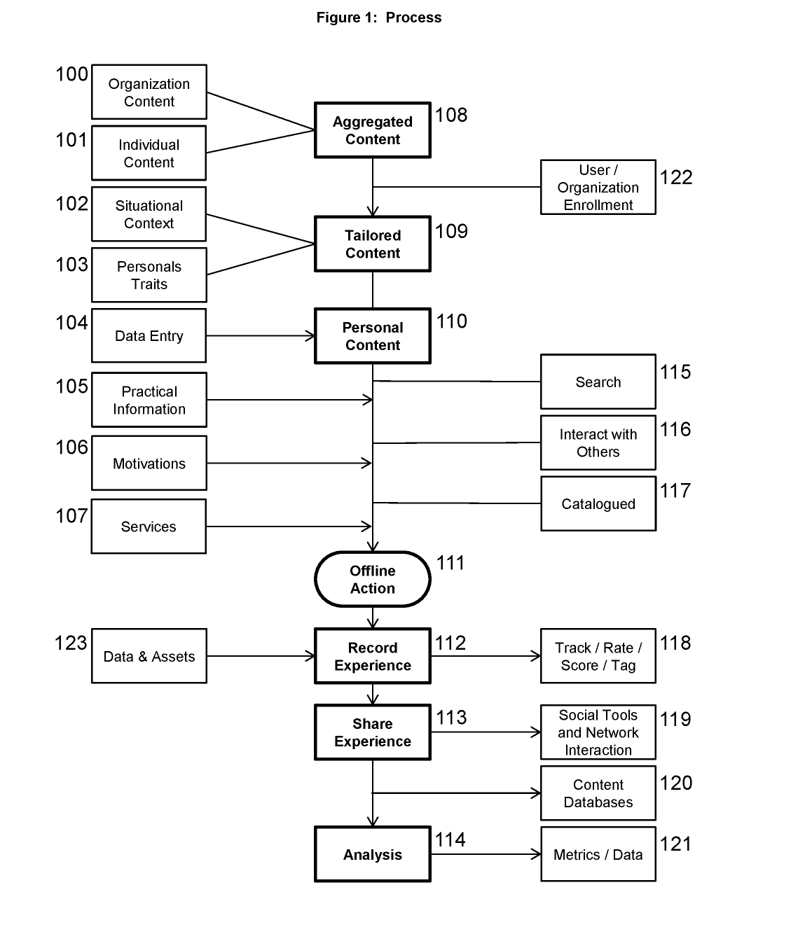

FIG. 1 illustrates the general process by which information (or data or content) is collected, stored, and used on a digital platform in relation to a non-digital context. Users (individuals and organizations) may enroll to participate in a program 122, creating accounts or unique identities. Via manual and automated collection processes, content is collected from enrolled and not enrolled organizations 100 and individuals 101 into an aggregated housing 108. An example of an automated collection process is when a user links his Twitter account to this system, such that whenever he tweets a particular phrase (such as #FunLife), then that content would be replicated in this system. This content is manipulated and filtered for relevancy to an individual user 109, and displayed through digital interface (web, mobile, wearable tech, and other digital devices like smart TV). This may include users' situational context 102, such as location or activity, as well as their personal attributes 103, such as demographics behavioral data. For example, when a Charlotte-based twenty-something sports-enthusiast in Charlotte opens the app on his phone, he will automatically see content offering sports ideas within Charlotte and posted by other twenty-somethings. Additional content or data may be manually entered into the system by users 104, using supported digital devices, including their likes, dislikes, goals, intent, and past experiences.

FIG. 1 further outlines the process by which the platform may supplement the content and data and combine it with services that aid its application. This includes the incorporation of practical information 105, including related venues, service providers, maps, information, and ratings. This is achieved through native and third party integrations with programs like Google Maps. For example, content such as “play basketball” may be complemented with information, such as a location, of where to purchase a basketball, as well as the direct ability to make that purchase via the system. Users and organizations may elect to utilize the associated integrated services 107, such as bookings or payment transactions.

Additionally in FIG. 1, gaming mechanics may be incorporated into the process to motivate user participation with the system and activation of specific content 106. These functions include notifications within a device or communication system, like SMS or email or native application, activated by triggers, including the user behaviors, network activities, preferences, related content and situational context. For example, if the user has a low score in the category of charitable experiences, the next time the user is within a certain geographic distance of a soup kitchen, the user would receive an automatic notification of a volunteer opportunity at that location. Additional motivating features may include scoring and rankings and tutorials and social pressure. All of this content and activities are catalogued 117 for easy retrieval and intuitive interaction, such as a to do list or completed gallery or calendar visualization.

FIG. 1 also describes the ability for users to search for content or individuals 115. This includes mechanisms for filtering and sorting and browsing the content by user-directed attributes, such as location, author, rating, difficulty, time, popularity, or categories. For example, a user may search for all experiences that involve eating (category), in Chicago (location), and can be completed within one hour (time). The application enables these activities to take place manually or automatically, such as with recommended content that meets a combination of criteria. Users may also interact with other users on this platform 116, including by challenging them to participate, inviting them to participate, recommending them to participate, communicating with them, encouraging them, thanking them, and following them. For example, a user who loves cooking is able to view all other nearby users who also love cooking and send them an invitation to join a cooking class at a particular time and place. A preferred embodiment of the processes is for the interactions to result in offline actions or additional content.

FIG. 1 further illustrates the process after a user participates in an offline experience 111, whether or not a result of influence by the platform. The user may record the experience 112, either by personal initiative or from automatic prompting. This recording is a translation of the physical experience into digital content (with corresponding data and linked assets such as location or temperature) 123. The mechanism for capturing this information includes web, mobile, and digital devices, including both manual entry by user and automatic capture by connected devices, including such examples as GPS tagging, video camera, and sound recording (for example, a smartphone microphone can monitor environmental noise and identify a TV show playing in the background). Types of content included may be code, text, scoring, photos, videos, voice, and descriptions or tags, such as category, location and people. In a preferred embodiment, this information is then linked to the user's account and/or profile, and has the option of being displayed in the form of lists, galleries, calendars, maps, or simply results in a corresponding action being triggered (such as a message being sent, or content being served, or access to another experience being granted as in a game with levels, or tracks of similar-themed actions being completed). An example of a track, collection, or series of content is if the user had completed 3 of 10 “Outdoor Adventure” actions. When relevant, the corresponding action mentioned above is also tracked, rated, and used in a scoring system 118, including the assignment of credit or impact to the originating and influencing users. An embodiment of this process includes tagging entries with a unique code that can be mapped back to the originating source (ie: the original creator of the content and the series of people that were inspired thereafter). This enables the system to map out the flow and influence of content and experiences across users and geographies and other segments, providing valuable insight, as well as motivating user activity when visually presented. An embodiment of the score includes the assessment of an individual's perceived age (versus real age), as calculated as a function of active days (days in which an experience or memorable event occurred) versus non-active days, and extrapolated over time and by incorporating common trends within age groups. Another embodiment of the score includes the incremental gain of an experience during a period or situation, potentially in which an experience would not normally have been gained (or not as valuable of an experience), creating a “profit” in the context of added life richness. For example, if a user who has never gone ice-skating tries ice-skating for the first time in his life, he would receive a higher score than a user who goes ice-skating on a regular basis.

After the experience has been recorded on the platform, FIG. 1 next shows how the corresponding content and data may be used and shared 113. First, the content could be shared external to the platform 119, manually and automatically (as established in user settings), via integration with tools, like SMS or email, and social media networks, like Facebook or Twitter. The content would be converted to the appropriate format and contain tracking and linking mechanisms, such that recipients would be directed to the originating content, and the content may continue to be monitored for influence. Secondly, the content becomes integrated into the platform databases, with the option to be made publically visible to all, part, or none of the users 120. This is communicated through a number of mechanisms, including an activity feed, notifications center, user profiles, and browsing lists.

FIG. 1 also shows an embodiment of how that activity and content and data on the platform is analyzed 114 in a number of ways (as illustrated in subsequent figures), such as with algorithms, and for a variety of uses that support the overall effectiveness of the platform. The output of the analysis comes in the form of data visualizations, including graphs, charts, pictures, designs, as well as scoring metrics 121. This provides users with an assessment on their status (personal and relative), including performance, balance of activity across categories, ranking versus others, progress, goals, path, earning incentives, and influence. For example, an output of analysis shown in the form of a graph may inform the user that over the past six months, his score has steadily increased each month, but that he is still below the average of his friends. This is used to encourage participation, improve quality of participation, and provide valuable feedback to users and clients in the form of data and insight. This relates to both individual and institutional users looking at groups.

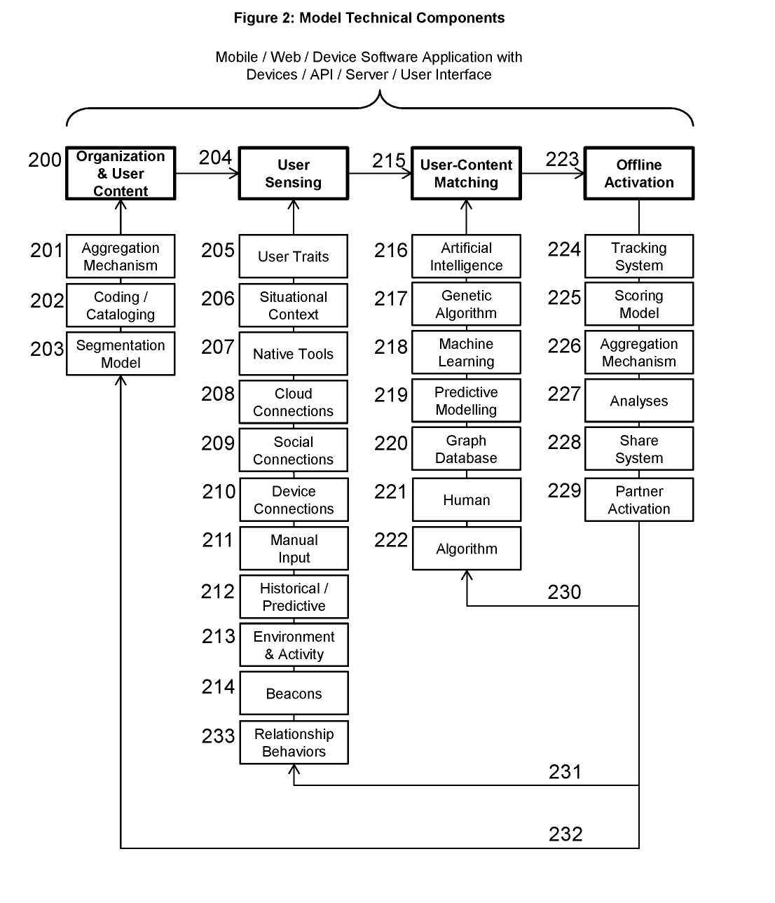

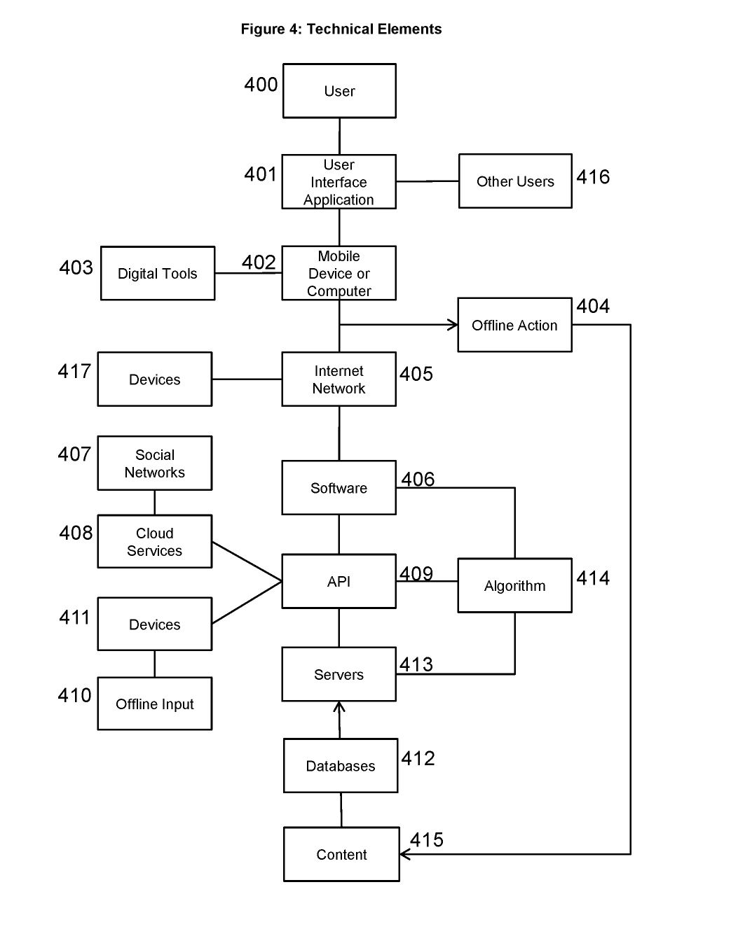

FIG. 2 illustrates a more detailed look at the mechanisms that enable the processes described in FIG. 1. These mechanisms leverage a combination of technical components, including devices (such as smartphones, computers, and components within), software (such as mobile applications and interfaces), and backend systems (such as APIs and servers). The technical specifications and interconnects of these components will be described in FIG. 4.

FIG. 2 begins with the organization of user content 200. Content and data 108 is aggregated from across multiple systems via input mechanisms (both automated and manual) by way of an interface and into a database for storage and retrieval 201. This information is then coded and cataloged 202 with tags and attributes (such as location, gender, etc.) by way of a software-based code and manually. The content is further segmented into buckets (such as outdoor activities, or quick activities) by software processes, including a natural language parsing service, for easier use 203.

FIG. 2 next shows the mechanisms and inputs 204 that may be included at various times and weightings to support the system's ability to determine the user's state of being and situational context 102. This includes defining the user's personal traits 205 (such as demographics, home address, relationship status), which is entered into the system through a manual interface 211 (such as via an app) or pulled automatically from existing data sources available online. The situational context of the user and user's connections 206 is derived from manual input (such as via an app) or through a combination of logic applications and native tools 207, such as using a smartphone device gps to look at location relative to home and work to assume the user's situational context is “commuting.” Additional information is sourced from peripheral devices 210 (like a pedometer), which may be connected to the system via wireless transmission (such as Bluetooth or WiFi), or via cloud-based connections 208, which include connections to the user's social graph 209, via applications such as Facebook Connect. The system also considers the historical data collected 212, such as past activities or inactivity (including records like a “sleeping” activity was previous done at x location, therefor location x may be home or a hotel), and environmental factors (such as weather or terrain) by cross-referencing various data sources like maps and programs and data from other systems via their APIs. Tapping into beacons (sound, visual, etc) 214 are also methods for computing environment location. Using coded logic rules, all of the above information is considered for the user, as well as the user's connections 233 to draw relevant conclusions based on their behavior and context. For example, if a user's husband is currently eating dinner, then that could be used to make an inference about the user also eating dinner.

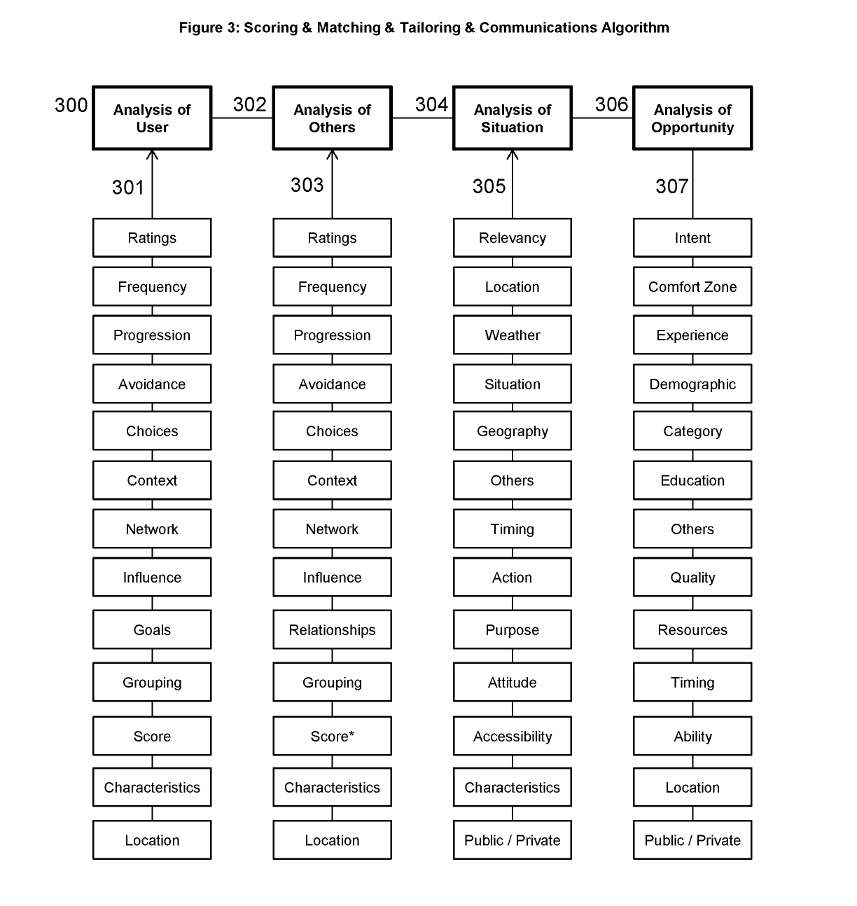

FIG. 2 next shows the technologies 215 used in some combination to process the content and data thus far into more relevant and/or actionable and/or tailored content and data 109 or communications. This includes the application of artificial intelligence 216 to make recommendations or high-likelihood behaviors or new segments of users or activities (such as “outdoor adventurers over the age of 50”). In this application, a user may provide data to the system about a future or current activity, the system may analyze the user's profile, identify the user's location or future location, and based on these data points propose that the user perform the activity in a certain way and/or using some marketed product or service. Genetic algorithms 217 are also used to manage large population datasets and identify sub-groups or trends that then result in custom-tailored content to their tastes and likes. Machine learning (including Naïve Bayes, and other statistical algorithms) 218 is how the system continues to evolve over time, getting smarter with continuously improving analyses of individuals and groups, as their behaviors and preferences and networks change over time and across situations. An embodiment of this capability includes the recommendation engine self-modifying based on a user's completed experiences as a result of a match. Predictive modelling 219 is used by looking at past information and identifying patterns to aid in the refinement of content and recommendations (for example, the likelihood of individual x to participate in activity y increases when friend z also participates, therefore, assign higher weighting to a recommendation if friend z is also planning to participate). This is particularly useful in finding and recommending content or activities to a group of individuals based on commonalities and likelihood of participation. A use case example: three friends are all looking to engage in an activity together, so the application will offer options that satisfy the respective preferences of all three. An embodiment of this feature includes a scheduling tool that identifies similar activities among sets of people, such as by looking at the “want to do” list of each person and looking for the same or similar entries. In the reverse process, this also applies to finding similar types of people to participate in an activity based on past experiences or type of individuals. A graph database 220 is also used to manage the complex datasets for individuals and groups. Lastly, human variables 221, such as preferences and selections and choices made by an individual user, help the system understand intent and discontent. An example of this may be presenting a user with three options of content representing different activity spaces and the direct selection being used to refine the results. All of these mechanisms are included by way of software, devices, and algorithms 222, of which FIG. 3 will go into greater detail.

FIG. 2 lastly illustrates the activities related to the offline activation of the content 223, and subsequent handling of the activity and the new content being generated from it. Items 224 thru 228 are referenced in FIG. 1 and FIG. 3 descriptions. Partner activation 229 refers to the interconnection between the system's digital content and the resulting activity taking place with a partner entity, such as a venue or a business or an institution. For example, system content may refer to “participating in a mud run” and the activation of such activity may take place in association with the National Mud Run Association courses. This online initiation and offline activation can be facilitated by the confirmation process of partner entity via applications including barcode scanner, GPS confirmation, promo code retrieval, and such. Partner activation also relates to the scoring and points system integrating between this platform and that of partner entities (such as loyalty programs) via an API interface. An example is if a user participates in an activity and receives points or benefits from a grocery store loyalty program, or if a user's activities warrant benefits from the partner entity (such as discounts or access or merchandise). The collective content and data from the offline activity and resulting analyses feeds back into the system, including the content aggregation 232, user sensing 231, and user-content matching 230.

FIG. 3 illustrates the inputs that make up the algorithms used for scoring content and users, matching content and users, tailoring content to users, and communicating with users. These inputs are combined from various sources, with various weightings, and computed in various combinations. This includes an analysis of the user 300 (from user-specific data sets 301), analysis of other users (from other users' data sets 303), analysis of the users situation (from situational data sets 305), and analysis of the content or actions (from content-related data sets 307). These are combined via software applications communicating with devices and platforms, and assigned numerical values and calculated using a weighting system (from 0 to 100%), prioritization system, and various rules that reflect the relationship between elements (for example, the presence of variable x may reduce the weighting of variable y). Part of the system includes a process by which these variables and weightings can be adjusted over time manually by the administrator as well as automatically via the software. An embodiment of the score may be as simple as the number of offline experiences logged for an individual, or aggregated for an organization, representing internal experiences or experiences with customers. For example, a sporting goods store may accumulate a score of “500” after 50 of its customers each engage in 10 suggested experiences.

The algorithm inputs illustrated in FIG. 3 include the following:

“Ratings” refers to the qualitative assessment of an activity or content by a user (across vectors including overall, richness, deviation, growth, impact, etc.) by way of a user interface, including a slider or numerical or visual representation. For example, after a user experiences a mud run, he may record the experience on the application and assign a 1-10 rating to various aspects of the experience.
“Frequency” refers to the rate or pace (or change in such) of participation by a user over time, as tracked by the system.
“Progression” refers to the level of participation over time, and across segments of activities (such as having completed 8/10 group x activities), and across degrees of activities (such as difficulty or rating), as tracked by the system and with user input.
“Avoidance” refers to the user's dismissal or ignoring of certain content at different stages. This is continuously monitored by the system, tracking which of the presented content is engaged with or not.
“Choices” refers to the individual selections and patterns of selections made by a user, whether as content participated in or selecting as wanting to participate in. This is continuously monitored by the system, tracking which of the presented content is engaged with or not.
“Context” refers to the situational context of a user at various points, ranging from current moment or prior moment or future moment. This is set by the user or by the system automatically.
“Network” refers to the interaction with people in the user's network within and outside of the system, both in terms of individuals as well as types of individuals (such as demographics or segments). This is monitored by the system by looking at interactions that take place.
“Influence” refers to the user's level of influence over other users, and other users' influence over the user, in terms of originating or promoting content that is accepted and or participated in. For example user x may have created content that influenced 10 other users to participate in. Using code that assigns unique identifiers to content, this influence tracking continues over ongoing degrees of separation, such than an individual could influence one hundred people, by influencing ten other users, who each influence ten other users. This influence also factors in the social sharing of content and user responses (including mechanisms like comments or thumbs up).
“Goals” refers to a user's status relative to their intent in participation, including desired levels of frequency or progression or influence or balance across categories or versus an individual or community norm. This is designated by the user, as well as general expectations set by the system administrator.
“Grouping” refers to the collections of content that the user interacts with, in terms of categories or themes or set attributes. This is manually identified and automatically through genetic algorithm of population data over time.
“Score” refers to the user's status, as calculated by an algorithm, which can be as simple as adding the number of activities accomplished, or as complex as including the multiple variables indicated in this figure.
“Characteristics” refer to the user's traits, such as demographics, which is useful in segmenting the user into a group of expectations and comparison to peers. This is identified by user-entered data as well as sourced from social networks and behaviors.
“Location” refers to the physical geography of the user (such as “NYC) and the relative placement of the user (such as “in a city”). This is sources from the devices' systems like GPS and integration into services like Google Maps.
“Relationships” refers to the interconnection among users, including familial, friendship, stranger, as well as the relative relationships like vicinity or grouping. This is sources from social graph information and user-entered data.
“Relevancy” refers to the degree in which a situation is appropriate for the user, such as “visit the dog park” for a non-dog owner. This can be measured through rules programmed into the model, as well as through general probability pulls from a machine learning database looking at trends and scenarios.
“Weather” refers to the climate qualities such as temperature and precipitation, as determined by the device itself, interconnected devices (like Nest), as well as interfaces with monitoring services like weather.com.
“Situation” refers to the users context including activity or environment or purpose (such “at work,” or “outside,” or “playing”) as determined by the user's designation or automatically by the system.
“Geography” refers to the specific area of the situation, as designated by an official source, as well as system-generated geo-fencing (such as home neighborhood).
“Others” refers to the users who are also involved in a particular situation or activity, such as a family member or friend, as determined by the user's designation or automatically by the system.
“Intent” refers to the user's expressed or unexpressed interest in particular content or activities, and may be designated by the user by way of the user's personal list of desired items.
“Action” refers to the physical activity the user is involved with, such as moving or stationary, which can be determined by the device accelerometer or GPS or cellular service or linked peripheral devices (such as a Nike Fuel Band). This also includes manually entered actions such as “cooking” or “waiting.”
“Purpose” refers to the higher order desire of the user in terms of accomplishment, including traits such as “doing good,” “learning,” “gaining richness,” etc. This is determined by pre-set options and user-selected choices.
“Attitude” relates to the user mindset within a given situation, such as stressed, excited, tired, etc. This is extrapolated from the context (ie: higher likelihood of being stressed at work), as well as text sentiment analysis from users' input.
“Accessibility” refers to the consideration of practical elements related to a situation, such as ease/difficulty of access, cost, likelihood. This is derived by content analysis, user designation, and pre-determined designations (ie: flying may be coded as low accessibility).
“Public/Private” refers to the likelihood that a situation is of a more personal nature (such as going to the bathroom) or relating to a more public or interpersonal setting (such as going to a restaurant). This is derived by content analysis, user designation, and pre-determined designations.
“Comfort Zone” refers to the qualitative assessment of one's natural sphere of acceptance for an activity. This is used to assess a user's natural inclination or likelihood to participate in an experience and is derived by content analysis of user segmentation, past behaviors, circle of social influence, user selection, and pre-determined designations (ie: skydiving may be rated as outside a typical user's comfort zone).
“Experience” relates to the degree of intensity of an experience across multiple factors including memorable, impactful, sharable, richness, and sensorial, as derived by content analysis, user selection, and pre-determined designations.
“Demographic” refers to the type of individual(s) who would relate to the opportunity in terms of receptivity to participation. These attributes include age, ethnicity, relationship status, health, economic level, interests, education, family status, etc. This is derived by content analysis, user selection, and pre-determined designations.
“Category” relates to the type of opportunity as part of a collection, such as adventurous, social, work, altruistic. This is derived by content analysis, user selection, and pre-determined designations.
“Education” refers to the relative skill or degree of understanding that is characteristic of the activity. For example, “build a treehouse” may require more skilled craftsman, though “carve a watermelon” my be less restrictive. This is derived by content analysis, user selection, and pre-determined designations.
“Quality” refers to the general tier of activity, from low to high. This is derived by content analysis, user selection, and pre-determined designations.
“Resources” refers to the materials associated with the activity. For example, “go skiing” may require equipment. This is derived by content analysis, user selection, and pre-determined designations.
“Timing” refers the relative degree of time commitment surrounding the experience, whether quick or extended. Plus, this is indicative of the relative appropriateness for time periods, including morning or evening, before work or at bedtime. This is derived by content analysis, user selection, and pre-determined designations.
“Ability” refers to a user's capacity for participation in an activity, such as requiring a particular degree of physical stamina, or knowledgebase. This is derived by content analysis, user selection, and pre-determined designations.

An embodiment of the algorithm, with inputs illustrated in FIG. 3, includes the identification of a score that represents the user's (or organization's) activity. This includes a direct score (for example: 3 experiences in a week create a score of 3) and a blended score (for example: 1 high-rated experience, one low-rated experience, and one mid-rated experience create a score of 2). Another embodiment of the algorithm includes similarity rankings for use in recommending content based off others' offline activity. For example, assuming user X and user Y have similar past experiences, and user X participates in a low-rated experience, then this experience will have a low recommendation for user Y.

FIG. 4 illustrates the mechanical and software components that contribute to the operation of the system. Beginning with the user 400, there is an application on devices, including mobile (including smartphones and tablets) 402, web (including computers) 405, and other digital products (including wearables, smart TV, refrigerator, etc.) that enables the user to interface with the system 401, with other users 416, and with content for submission and retrieval and interaction. This application is a front-end software program 406 that utilizes the device processor and input/output elements to link the user to the device tools 403 (such as the GPS utility), peripheral tools (such as devices like a Bluetooth pedometer, thermostat, camera, etc.), offline actions 404, and the backend services.

The backend services, as illustrated in FIG. 4, include the API 409, which is computer code that manages the manipulation of data and content, as well as the connection to other parts of the system. This includes accessing the algorithm code 414 and the data 415 stored in databases 412 that are hosted on the server 413, which is accessed via wireless or WiFi and cloud connections. The data and content is additionally retrieved by the API from devices 411, submitted manually 410 (in the case of user submission via the device interface) and automatically (such from the device GPS). Other data and content is accessed via cloud services 408 that connect to other system APIs, as well as social networks 407 (such as Facebook).

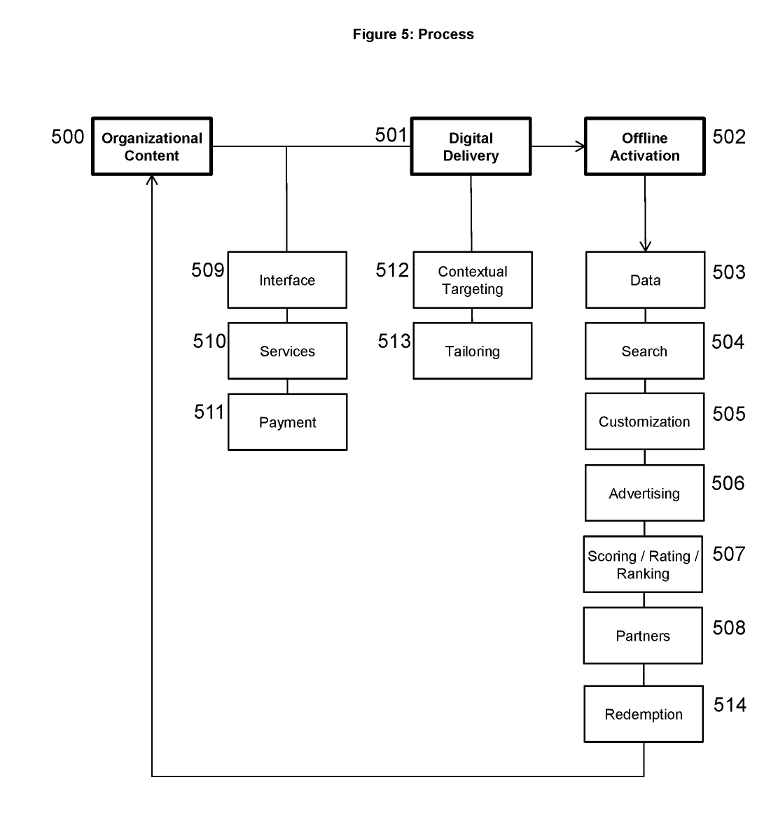

FIG. 5 illustrates an exemplary embodiment of the process by which an organization uses this system to interact with members (such as users, customers, employees, etc.). An embodiment of the system involves the organization (or its members) submitting content 500 via a mobile and web or other digital interface 509, which includes a dashboard for managing the account services and activity 510, such as organizing the content or creating linked profiles for individual members within the organization. Payments 511 may also be managed here, with payment options that include among others a subscription-based usage, as well as a pay-per-performance model, in which the organization is charged a fee each time digital content is acted upon by users in an offline context. A pricing model includes both fixed and variable options, such a bidding system, in which organizations can purchase user life segments or contextual triggers (such as “after school playtime” or “prom date”), which effectively links brands and brand content to users' associated offline life experiences. An example of an embodiment of this linkage on the front end is if Kroger has bid on the trigger for “users located (by gps) within 5 miles of a grocery store,” which means that they get priority ranking (or exclusive access) when it's appropriate for branded content in that context. This includes a contextual triggered notification alongside this, such as “Going shopping, consider this . . . ”. An embodiment of this linkage on the backend includes a brand logo being affixed to a corresponding image or content unit created within the life segment. The content is then delivered to users via the digital application 501.

During the process illustrated in FIG. 5, the content may be tailored to an individual user or group of users 513. This includes modifying the content to be time or geographically relevant, such as by assigning a local destination. For example, generic content may include “go to a florist” and the tailored version of the content may be “go to Jim's florist two blocks away.” This is accomplished by identifying the users' contextual situation (such as location), and leveraging an API interface with existing content databases (such as Google Maps). Through this process of contextual targeting 512, the content can be designated for delivery to only certain user groups that fit the desired characteristics, as determined by the organization. For example, Organization Z may determine that content X should be delivered to users who are in a train station.

After the content in FIG. 5 is digitally delivered to users, users may activate the content with offline participation 502. The resulting user activity generates data in the form of user behavior, user segmentation, influence, user intent, location, and other. This data from offline behaviors and user context is organized in a way that can be used to refine search results 509 within the application (such as “what to do for dinner”) and off-platform (such as Google or online shopping) 509. The resulting data is also able to be used in developing customized messaging and propositions by the organization 505. A useful embodiment of this application is in developing and delivering advertising campaigns 506, because this bridges the offline activity and context with online content. The activation information may also be used in a scoring program 507, in which content is rated and organizations are ranked by various criteria (including impact and influence), such as in a leaderboard among organizations. A group's multiple representative may also be linked together to form a net score involving all related users, such as within a geography (ie: Atlanta score), or an organization (ie: Coca-Cola Company score), or an association (ie: family or friend group), or a division (ie: Olay North America R&D managers). This can be further repurposed in off-platform communications and by partner organizations 508, such as by driving users to participate in monitored offline activities, like purchases or redemptions of offers and awards 514. The collection of this data, and its usage, feeds back to the original organization 500 for further refinement and extension of content.

In broad embodiment, the present invention is an application that links real-world experiences to digital content. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

As will be appreciated by one of ordinary skill in the art in view of this disclosure, the invention may be embodied as an apparatus (including, for example, a system, machine, device, computer program product, or any other apparatus), method (including, for example, a business process, computer-implemented process, or any other process), a system, a computer program product, and/or any combination of the foregoing. Accordingly, embodiments of the invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the invention may take the form of a computer program product having a computer-readable storage medium having computer-executable program code embodied in the medium.

Reference in this specification to “one embodiment” or “an embodiment” means that a particular feature, structure, or characteristic described in connection with the embodiments is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Any suitable computer-readable medium may be utilized. The computer-readable medium may be, for example but not limited to, an electronic, magnetic, optical, electromagnetic, infrared, or semiconductor system, apparatus, or device. For example, in one embodiment, the computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or other tangible optical or magnetic storage device.

Computer-executable program code for carrying out operations of the invention may be written in object oriented, scripted and/or unscripted programming languages such as Java, Perl, Smalltalk, C++, SAS, SQL, or the like. However, the computer-executable program code portions for carrying out operations of the invention may also be written in conventional procedural programming languages, such as the “C” programming language or similar programming languages.

Some embodiments of the invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The computer-executable program code may also be loaded onto a computer or other programmable data processing apparatus to cause a series of operational steps to be performed on the computer or other programmable apparatus to produce a computer-implemented process such that the computer-executable program code which executes on the computer or other programmable apparatus provides steps for implementing the functions/acts specified in the flowchart and/or block diagram block(s). Alternatively, computer-implemented steps or acts may be combined with operator or human implemented steps or acts in order to carry out an embodiment of the invention.

1. A method comprising:
detecting the real life situation of a user of a computer-implemented program, the real life situation including at least one of the following: the physical activity of the user, the past physical activity, the intended physical activity of the user, the contextual setting of the user, and the state of being of the user, the personal attributes of the user of a computer-implemented program; and
changing, using a processor, an attribute of virtual content displayed to a user and non-user of the computer-implemented program, on this computer-implemented program and other networked computer-implemented programs, based on detecting the real life situation of the user, and other users, of the computer-implemented program, the changing of the attribute of the virtual content representing the real life physical action (also referred to as “experience”) by the user, and other users, of the computer-implemented program, wherein the changing of the attribute of the virtual content reflects a plurality of performances of the physical action by the user.

2. The method of claim 1, wherein the attribute of the virtual content is a level of accomplishment of the user of the computer-implemented program.

3. The method of claim 1, wherein the attribute of the virtual content is a representation of a score that includes a user's influence on other user's participation in real life physical actions.

4. The method of claim 1, wherein the attribute of the virtual content is a representation of a real life physical action for the user to perform, or which has already been performed by the user.

5. The method of claim 1, wherein the attribute of the virtual content is either a representation of a real life physical action for at least two users in a group to perform, as determined by shared attributes among the users of that group; or a representation of at least one other user, as determined by the users having a similar real life situation.

6. The method of claim 1, wherein the visual characteristic reflects a brand associated with at least one of the following: a real life situation, and a physical action.

7. The method of claim 1, further comprising changing the virtual content and detecting the real life situation of a user and detecting the physical activity of a user, based on information received from other sources, including third-party programs and other users of the computer-implemented program.

8. A system comprising:
a processor-implemented program networking system configured to:
detect the real life situation of a user of a computer-implemented program, the real life situation including at least one of the following: the physical activity of the user, the past physical activity, the intended physical activity of the user, the contextual setting of the user, and the state of being of the user, the personal attributes of the user of a computer-implemented program; and
change an attribute of virtual content displayed to a user and non-user of the computer-implemented program, on this computer-implemented program and other networked computer-implemented programs, based on detecting the real life situation of the user, and other users, of the computer-implemented program, the changing of the attribute of the virtual content representing the real life physical action (also referred to as “experience”) by the user, and other users, of the computer-implemented program, wherein the changing of the attribute of the virtual content reflects a plurality of performances of the physical action by the user.

9. The system of claim 8, wherein the attribute of the virtual content is a level of accomplishment of the user of the computer-implemented program.

10. The system of claim 8, wherein the attribute of the virtual content is a representation of a score that includes a user's influence on other user's participation in real life physical actions.

11. The system of claim 8, wherein the attribute of the virtual content is a representation of a real life physical action for the user to perform, or which has already been performed by the user.

12. The system of claim 8, wherein the attribute of the virtual content is either a representation of a real life physical action for at least two users in a group to perform, as determined by shared attributes among the users of that group; or a representation of at least one other user, as determined by the users having a similar real life situation.

13. The system of claim 8, wherein the visual characteristic reflects a brand associated with at least one of the following: a real life situation and a physical action.

14. The system of claim 8, wherein the processor-implemented program networking system is configured to change the virtual content and detect the real life situation of a user and detect the physical activity of a user, based on information received from other sources, including third-party programs and other users of the computer-implemented program.

15. A non-transitory computer-readable medium comprising a set of instructions that, when executed by at least one processor of a computer system, cause the computer system to perform operations comprising:
detecting the real life situation of a user of a computer-implemented program, the real life situation including at least one of the following: the physical activity of the user, the past physical activity, the intended physical activity of the user, the contextual setting of the user, and the state of being of the user, the personal attributes of the user of a computer-implemented program; and
changing an attribute of virtual content displayed to a user and non-user of the computer-implemented program, on this computer-implemented program and other networked computer-implemented programs, based on detecting the real life situation of the user, and other users, of the computer-implemented program, the changing of the attribute of the virtual content representing the real life physical action (also referred to as “experience”) by the user, and other users, of the computer-implemented program, wherein the changing of the attribute of the virtual content reflects a plurality of performances of the physical action by the user.

16. The non-transitory computer-readable medium of claim 15, wherein the attribute of the virtual content is a level of accomplishment of the user of the computer-implemented program.

17. The non-transitory computer-readable medium of claim 15, wherein the attribute of the virtual content is a representation of a score that includes a user's influence on other user's participation in real life physical actions.

18. The non-transitory computer-readable medium of claim 15, wherein the attribute of the virtual content is a representation of a real life physical action for the user to perform, or which has already been performed by the user.

19. The non-transitory computer-readable medium of claim 15, wherein the attribute of the virtual content is either a representation of a real life physical action for at least two users in a group to perform, as determined by shared attributes among the users of that group; or a representation of at least one other user, as determined by the users having a similar real life situation.

20. The non-transitory computer-readable medium of claim 15, wherein the visual characteristic reflects a brand associated with at least one of the following: a real life situation and a physical action.

21. The non-transitory computer-readable medium of claim 15, further comprising changing the virtual content and detecting the real life situation of a user and detecting the physical activity of a user, based on information received from other sources, including third-party programs and other users of the computer-implemented program.
